(19) United States
(12) Patent Application Publication
(10) Pub. No.: US 2006/0236552 A1
(43) Pub. Date: Oct. 26, 2006

(54) Apparatus and method for opening jars

(76) Inventor: Mark T. Giles, Forked River, NJ (US)

Correspondence Address: MICHAEL R. PHILLIPS, P.O. BOX 1818, TOMS RIVER, NJ, 08754-1818, US

(21) Appl. No.: 11/114,324

(22) Filed: Apr. 26, 2005

(51) Int. Cl. B26F 1/32

(52) U.S. Cl. 30/366; 30/367

(57) ABSTRACT

Apparatus and method for facilitating the opening of vacuum-sealed jars by punching a hole through the jar cap and removing the implement to relieve the vacuum. The apparatus has a pin mounted on a plunger that is supported on a compression spring. The compression spring serves to raise the pin and plunger after use. A magnetic pad is affixed to a lower surface of the apparatus for attaching to a jar cap during use.

### FIELD OF THE INVENTION

The present invention relates to the field of kitchen tools, and more particularly to kitchen tools and methods for overcoming the torque needed to open vacuum sealed jars.

### BACKGROUND OF THE INVENTION

Many foods are sold in jars that are sealed before the cooked contents cool to create an internal vacuum condition to securely hold the jar cap in place and effectively protect the contents from becoming contaminated. Vacuum sealing pertains both to jar caps with full threading requiring a complete rotation or more to be removed and quick-release jar caps requiring less than a quarter turn to be removed. A problem exists in that removing vacuum-sealed jar caps requires the application of significantly more torque, in the range of 33% to 100% more torque, than needed to remove the same caps without vacuum seals. Because of this greater torque requirement, many people have difficulty removing a cap from a vacuum sealed jar. When the person is older, or has less hand strength than average, removing a vacuum-sealed cap from a jar becomes a major challenge.

Over the years, different devices have been developed and sold to attempt to overcome the problem of removing the vacuum-sealed jar cap. Some of these devices serve as a tool to increase the gripping force and torque the person can apply to the cap through leverage. Some are simply an elastomeric frictional pad to increase the amount of grip the person applies with the same force. Some are electrically driven clamping chuck devices to unscrew jar caps. In all cases, the vacuum has to be overcome, and traditionally a greater torque has been the available means to do so. The present invention overcomes the problem through a novel and simple approach.

### SUMMARY OF THE INVENTION

The jar opening apparatus and method of the invention provides means for relieving the vacuum under which a jar cap is sealed to reduce the torque required for opening the jar. A sharply pointed pin is mounted to a plunger that can be depressed against the force of a compression spring. The jar opening apparatus is placed on a vacuum-sealed jar cap to be opened. When the plunger is depressed, the pin is extended through an orifice in a base portion to punch a hole through the jar cap, releasing the vacuum. The compression spring then retracts the pin into the orifice, and ambient air enters the jar to relieve the vacuum and reduce the amount of torque needed to open the jar. In the preferred embodiment, a magnetic pad is mounted to the base of the jar opening device securing attachment to the jar cap during use, and to a refrigerator or other steel surface for storage.

### BRIEF DESCRIPTION OF THE DRAWINGS

The present invention is best understood in conjunction with the accompanying drawing figures in which like elements are identified by similar reference numerals and wherein:

FIG. 1 is a front elevation view of the jar opening apparatus of the invention positioned on a capped jar, the jar and cap shown in dashed lines.

FIG. 2 is a cross sectional view of the jar opening apparatus of FIG. 1 taken in the direction indicated by line 2-2 with the plunger in raised position.

FIG. 3 is a cross sectional view of the jar opening apparatus of FIG. 1 taken in the direction indicated by line 2-2 with the plunger depressed and the punching pin extended.

### DETAILED DESCRIPTION OF THE PREFERRED EMBODIMENT:

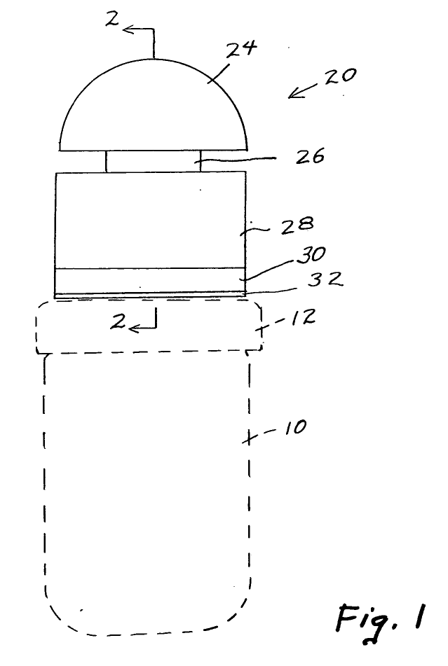

Referring to FIG. 1, a jar 10 and a jar cap 12 are illustrated in dashed lines. Cap 12 may be of the type requiring one or more complete rotations to be removed from jar 10 or a quick-release type requiring less than a quarter turn to be removed. In either type cap, sealing under vacuum has been done and cap removal requires the application of considerable torque. In all practical applications of the present invention, jar 10 is oriented vertically.

According to the description herein, the present invention is directed to puncturing the cap of a vacuum-sealed jar so as to reduce the pressure differential on the jar cap and lessen the torque needed to rotate and remove the cap. An implement is used for puncturing the cap, and the implement is then removed from the punched hole. With a hole made through the cap, the pressure within the jar equalizes with ambient pressure allowing the cap to be rotated and removed more easily.

The apparatus 20 for removing jar caps sealed under vacuum is depicted as a cap punch device shown residing on top of cap 12. Cap punch device 20 has a head 24 mounted to a plunger 26 that is adapted for being moved downwardly in response to downward pressure on head 24. While head 24 is illustrated as being hemi-spherical, other shapes including flat are applicable within the scope of the present invention. Plunger 26 is partly encased in a housing 28 that is affixed to a base 30. In the preferred embodiment, a magnetic pad 32 is assembled to the lower surface of base 30. Magnetic pad 32 removably holds cap punch device 20 to jar cap 12 during use. When cap punch device 20 is not being used, magnetic pad 32 allows temporary mounting of cap punch device 20 on a convenient steel surface, for example a panel of a refrigerator. Magnetic pad 32 is formed of flexible sheet magnetic material, as is known. Alternatively, base 30 may be formed of a magnetized plate.

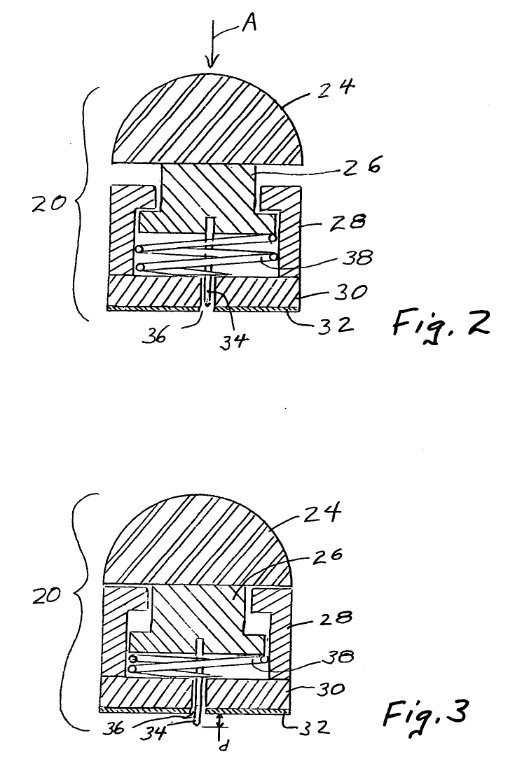

Referring now to FIG. 2, cap punch device 20 is shown in a cross sectional view taken along line 2-2 of FIG. 1. As noted above, head 24 is mounted to plunger 26, and housing 28 is affixed to base 30 by conventional means, for example an adhesive or screw fasteners (not shown). Plunger 26 is seen to have the cross sectional shape of an inverted letter “T” with a lower rim extending radially outward, and housing 28 has an inwardly extending upper rim so that when cap punch device 20 is assembled, plunger 26 is captive within housing 28. The lower surface of plunger 26 rests on biasing member 38, for example a compression spring, that allows assembled head 24 and plunger 26 to be moved downwardly in the direction indicated by arrow A and raises head 24 and plunger 26 when the downward pressure is released. Biasing member 38 is contained within housing 28 by the assembly of base 30. Base 30 has an orifice 36 formed axially therethrough. A puncturing member, i.e. pin 34, is fixed into an axial hole in the lower surface of plunger 26 with an exposed length configured to reside totally within housing 28 and orifice 36 when plunger 26 is in the raised position. In the preferred embodiment of the present invention, pin 34 and orifice 36 are located centrally in plunger 26 and base 30 respectively. Pin 34 is formed of a hard metal, preferably stainless steel, and having a sharp point on its exposed end to readily punch through a metal jar cap 12 (FIG. 1). Other components of cap punch device 20 are made of any conventional material, including metals and plastic resins.

Referring now to FIG. 3, cap punch 20 is shown with plunger 26 in depressed condition with biasing means 38 compressed and pin 34 extending a distance d below base 30 and magnet 32. According to the present invention as illustrated, depression of head 24 and plunger 26 applies force through pin 34 in a direction substantially perpendicular to the upper surface of jar cap 12 (FIG. 1) to punch a hole therethrough. As will be understood, in the punching condition illustrated in FIG. 3, with cap punch device 20 mounted on cap 12 of jar 10 (FIG. 1), pin 34 will be pushed through the upper surface of cap 12 to make a hole therethrough. When pressure is removed from head 24, head 24, plunger 26 and pin 34 are raised by biasing means 38 to resume the condition illustrated in FIG. 2. Removal of pin 34 from the hole punched through cap 12 allows air to enter jar 10 and relieve the vacuum therein. Cap punch device 20 is then removed from cap 12, and cap 12 is unscrewed from jar 10 with less torque than would have been needed with the vacuum held within jar 10. A reduction in torque required to unscrew cap 12 from jar 10 of between 25% and 60% has been achieved by use of the apparatus of the present invention for opening jars.

While the description above discloses preferred embodiments of the present invention, it is contemplated that numerous variations and modifications of the invention are possible and are considered to be within the scope of the claims that follow.

What is claimed is:

1. Apparatus for opening jars, comprising:
a. means for making a hole in a jar cap by application of a force substantially perpendicular to an upper surface of the cap; and
b. biasing means in contact with and positioned for retracting the means for making a hole in the cap when the force is released.

2. The apparatus as described in claim 1, wherein the means for making a hole in the cap comprises a pin mounted to a plunger that is movable in a direction substantially perpendicular to an upper surface of the cap.

3. The apparatus as described in claim 1, wherein the biasing means for retracting the means for making a hole in the cap comprises a compression spring in contact therewith.

4. The apparatus as described in claim 2, further comprising housing means to contain the pin, the plunger and the biasing means.

5. The apparatus as described in claim 4, wherein the plunger has an outwardly extending lower rim and the housing has an inwardly extending upper rim configured to contain the lower rim of the plunger, the housing means being further assembled with a base.

6. The apparatus as described in claim 5, wherein the base is formed with a central orifice configured to allow the pin to pass therethrough.

7. The apparatus as described in claim 1, further comprising means to secure the apparatus to a jar cap during use.

8. The apparatus as described in claim 7, wherein the means to secure comprises a magnet.

9. Apparatus for opening jars, comprising:
a. a vertically movable plunger having a pin assembled axially to a lower surface thereof;
b. biasing means in contact with the lower surface of the plunger in a manner to urge the plunger to move upwardly;
c. a housing formed to slidingly receive and retain the plunger and biasing means therewithin; and
d. means to secure the apparatus to a jar cap during use.

10. The apparatus as described in claim 9, wherein the means to secure the apparatus to a jar cap comprises a magnet.

11. The apparatus as described in claim 10, wherein the magnet comprises a magnetic pad.

12. The apparatus as described in claim 9, wherein the biasing means comprises a compression spring.

13. The apparatus as described in claim 9, wherein the plunger has an outwardly extending lower rim and the housing has an inwardly extending upper rim configured to contain the lower rim of the plunger, the housing being further assembled with a base.

14. A method for opening vacuum-sealed jars, comprising the steps of:
a. puncturing a cap of a vacuum-sealed jar with an implement;
b. removing the implement from a hole formed in the jar cap to relieve the vacuum within the jar; and
c. rotating and removing the jar cap from the jar.

15. The method described in claim 14, wherein the step of puncturing the cap comprises forcing the implement through a surface of the cap to form a hole therethrough.

16. The method described in claim 14, wherein the step of removing the implement comprises biasing the implement in a direction outward of the jar cap.
